(19) United States
(12) Patent Application Publication
(10) Pub. No.: US 2013/0148919 A1
(43) Pub. Date: Jun. 13, 2013

(54) ROLLING BEARING AND MANUFACTURING METHOD THEREOF

(71) Applicants: Akira Matsuo, Tochigi (JP); Shunsuke Takeguchi, Tochigi (JP); Shinji Oishi, Shizuoka (JP); Masashi Nishimura, Shizuoka (JP); Tsutomu Nakagawa, Shizuoka (JP)

(72) Inventors: Akira Matsuo, Tochigi (JP); Shunsuke Takeguchi, Tochigi (JP); Shinji Oishi, Shizuoka (JP); Masashi Nishimura, Shizuoka (JP); Tsutomu Nakagawa, Shizuoka (JP)

(73) Assignee: NTN CORPORATION, Osaka (JP)

(21) Appl. No.: 13/699,086

(22) PCT Filed: May 19, 2011
(86) PCT No.: PCT/JP2011/061562

§ 371 Date: Jan. 24, 2013

(30) Foreign Application Priority Data
May 21, 2010 (JP) 2010-117746

(51) Int. Cl. F16C 33/46; B22F 3/02; B22F 5/00; B21K 1/05

(52) U.S. Cl. CPC F16C 33/46; B21K 1/05; B22F 3/02; B22F 5/00
USPC 384/572; 419/66

(57) ABSTRACT

The present invention provides a rolling bearing which is excellent in strength, rigidity, heat resistance, and dimensional accuracy while being able to hold rolling elements in a stable manner and reduce manufacturing cost without degrading performance as a bearing and a manufacturing method for the rolling bearing. To achieve the object, the present invention adopts a rolling bearing including a cage provided with a plurality of pockets for housing and hold the rolling elements arranged at specific intervals in a circumferential direction in a peripheral wall of a cylindrical member. The cage is formed integrally by metal powder injection molding; and the cage includes a housing space for the rolling elements and a rolling-element fall-out prevention structure is formed by applying compressive working to an outer edge of the housing space in a direction from an outer circumferential surface toward a radial center of the cage.

### TECHNICAL FIELD

The present invention relates to a rolling bearing and manufacturing method thereof, and more particularly, to a rolling bearing which has a cage formed integrally by metal injection molding, and more specifically, by metal powder injection molding, and which includes structure for preventing the rolling-element fall-out; and manufacturing method of the rolling bearing.

### BACKGROUND ART

Rolling bearings are indispensable components for machines which include rotating parts and play a role transmitting a power smoothly by reducing friction as much as possible. So, the rolling bearings have conventionally been suitably used for rotating parts of various machines. Also today, the rolling bearings are used, for example, in various parts of automobiles, household electrical products, office automation equipment, for example.

Note that, in automobiles, due to the requirement for improved fuel consumption rate as well as cost reduction by reducing processing steps in response to market demand, the materials to be used in the engine components tends to change from iron which is a current mainstream material to aluminum. However, when aluminum, which is inferior in shear strength, is used for engine components, it is inevitable to increase wall thickness at some portion due to the requirement to assure strength equivalent to that of iron. Thus, downsizing in the rolling bearings is required to compensate size increases caused by engine components made of aluminum. Also, long service life and low cost are required on the rolling bearings used as engine components, and high dimensional accuracy is required on a cage for holding the rolling elements which is component of the rolling bearing to minimize contact resistance as well.

To form the cage with high dimensional accuracy at low cost, for example, Patent Document 1 (Japanese Patent Laid-Open No. 2001-82498) discloses a constant-velocity universal joint made of sintered metal by metal injection molding (MIM). Specifically, Patent Document 1 proposes the constant-velocity universal joint, comprising an outer joint member provided with a plurality of guide grooves formed on a spherical inside surface; an inner joint member with a plurality of guide grooves provided on a spherical outside surface; torque transmission balls respectively arranged in a plurality of ball tracks formed by the guide grooves of the outer joint member and the guide grooves of the inner joint member facing each other; and a cage in which a plural window type pockets are formed to house and hold the respective torque transmission balls, wherein the cage including the pockets is formed by cast molding (metal injection molding).

Since the cage of the constant-velocity universal joint disclosed in Patent Document 1 is made of sintered metal by metal injection molding and a metal part is directly formed in a shape close to a finished part shape, the shape is formed with high dimensional accuracy. However, employing of a metal injection molding to obtain a product having a so-called undercut at the same time is not practical because it requires complicate mold shape and frequent mold maintenance, and it increases the manufacturing cost greatly. Note that, the undercut shape is a concave shape formed on a side wall of the molded part, making it impossible to release the molded article as it is from the mold.

As a technology for forming undercut shapes employing injection molding technology without the complicated mold, a synthetic-resin rolling bearing cage is disclosed in Patent Document 2 (Japanese Patent No. 3651813), for example. Specifically, Patent Document 2 discloses a synthetic-resin rolling bearing cage, comprising a plurality of pockets for housing rollers formed at specific intervals along a circumferential direction; and roller stoppers projecting toward the pockets and formed on inner circumferential edges or outer circumferential edges of pillars between the pockets, wherein a concave groove for elastically deforming the roller stoppers in the circumferential direction is formed around an entire circumference of a base of the roller stoppers.

The structure of the synthetic-resin rolling bearing cage according to cited Document 2 can elastically deform the roller stoppers easily in the circumferential direction by mean of the groove around the base of the roller stoppers by utilizing properties of popular resin having both elasticity and viscosity. The cage according to cited Document 2 can prevent snap in the base of the roller stoppers when the molding tool used for forming of the pockets by injection molding is released in an outer circumferential direction of the cage. That is, the synthetic-resin cage according to cited Document 2 achieves undercut shapes forming in an injection molding.

However, the reason why the synthetic-resin cage according to cited Document 2 enables the forming of undercut shapes in an injection molding is material properties of the resin and cannot be applied to metal cages with high rigidity. When differences in material properties between resin and metal are considered, synthetic-resin cages are inferior in strength, rigidity, and heat resistance to metal cages and have disadvantages such as, shrinkage immediately after molding and dimensional changes with time due to a large coefficient of thermal expansion. So, it cannot be used at sites such as internal combustion engines, which require the above-mentioned properties.

As described above, as the conventional rolling bearings applicable to parts which require strength, rigidity, and heat resistance, and other properties and provided with a rolling-element fall-out prevention structure are often produced as follows: a basic cross sectional shape of a cage is formed by press forming a strip, then pocket holes for housing rolling elements are punched out, the strip is cut to a specific length and bent into a ring shape, and both edges of the ring-shaped strip are welded together. The cage formed in this way by employing welding has the advantages in increased production efficiency and cost reduction compared to cages formed by just pressing or machining. However, with the conventional rolling bearings formed by employing welding, the pocket holes for housing the rolling elements are tapered narrow at a spherical inside side when the strip-shaped member is bent into a ring shape, and it sometimes makes holding of the rolling elements in a stable manner difficult.

Then, for example, Patent Document 3 (Japanese Patent Laid-Open No. 2000-274439) discloses a welded cage which can secure a sufficient amount of lubricant and prevent roller skew (tilt) even when the cage deflects in a radial direction. That is, Patent Document 3 discloses a so-called needle rolling bearing among types of rolling bearings. Specifically, Patent Document 3 discloses a welded cage formed by welding both ends of a ring-shaped strip of base material provided with a plurality of pocket holes for housing rollers (rolling elements), wherein each of the pocket holes has circumferential guide surfaces and a circumferential roller stopper surface; and the circumferential guide surfaces and the circumferential roller stopper surface are substantially parallel to a normal surface at a circumferential center of the pocket hole.

Next, Patent Document 4 (Japanese Patent Laid-Open No. 2002-106575) discloses a cage for a radial rolling bearing in which even when a radial rolling bearing whose roller diameter to PCD (pitch circle diameter) ratio exceeds 0.12 is applied, the cage can prevent the rollers from falling out outward in the radial direction and hardly break in installation of the rollers into pockets. That is, Patent Document 4 discloses a so-called needle rolling bearing among types of rolling bearing. Specifically, in the cage according to Patent Document 4, to hold rollers in a stable manner, convex retainers provided on a peripheral outer side at both ends of each cage pillar are formed along curved surfaces of the rollers by plastic deformation, and the total width of parts subjected to the plastic deformation is 30% or more of pillar width.

### PATENT DOCUMENTS

[Patent Document 1] Japanese Patent Laid-Open No. 2001-82498
[Patent Document 2] Japanese Patent No. 3651813
[Patent Document 3] Japanese Patent Laid-Open No. 2000-274439
[Patent Document 4] Japanese Patent Laid-Open No. 2002-106575

### Problems to be Solved

However, in the case of the welded cage disclosed in Patent Document 3 described above, when the circumferential guide surfaces and circumferential roller stopper surfaces of the pocket holes are formed in the strip of base material, steps are further required for forming of an angle with respect to the normal surface of the strip of base material such that the circumferential guide surfaces and circumferential roller stopper surfaces will be substantially parallel to the normal surfaces in the circumferential centers of the respective pocket holes and punch out the strip of base material at least twice on one side and the other side in a length direction.

Also, the welded cage according to Patent Document 3 is formed by joining together ends of the steel-strip by welding as conventional manner, but with a forming method which uses welding, there are inevitably deviations in weld bead projection, and it is difficult to form a shape with high accuracy and it is necessary to provide a step and facilities for a welding operation. Therefore, the welded cage according to Patent Document 3 cannot fully meet market demand for cost reduction.

Next, in the cage according to Patent Document 4, various steps are required before finishing the product including: a step for forming the pillars by punching out a flat plate member, a step for bending the flat plate member into a ring shape, a step for joining together both ends of the flat plate member by welding for example, and a step for plastically deforming the convex retainers to hold the rollers. Therefore, because the welded cage according to Patent Document 4 involves large deviations in the shape of the cage, product quality is deteriorated and market demand for cost reduction is not fully satisfied.

The present invention has been achieved in view of the above problems and has an object to provide a rolling bearing which is excellent in strength, rigidity, heat resistance, and dimensional accuracy while being able to hold rolling elements stably and reduce manufacturing cost without degrading performance as a bearing and to provide a manufacturing method for the rolling bearing.

### SUMMARY OF THE INVENTION

Thus, the present inventors have conducted diligent studies and solved the above problems by adopting a rolling bearing provided with a cage formed integrally by metal injection molding, in particular, metal powder injection molding, and applying minimum machining. Then, the present invention will be described below.

Rolling bearing according to the present invention: a rolling bearing according to the present invention is characterized in comprising a cage provided with a plurality of pockets for housing and hold rolling elements arranged at specific intervals in a circumferential direction in a peripheral wall of a cylindrical member, wherein: the cage is formed integrally by metal powder injection molding; and the cage includes a housing space for the rolling elements and a rolling-element fall-out prevention structure provided in the housing space.

In the rolling bearing according to the present invention, the rolling-element fall-out prevention structure is preferable to be formed by applying compressive plastic working to an outer edge of the housing space in the direction from an outer circumferential surface toward a radial center of the cage.

In the rolling bearing according to the present invention, the rolling-element fall-out prevention structure is preferable to be formed by applying plastic bending to projections protruding radially from an outer circumferential surface of the cage to outward.

In the rolling bearing according to the present invention, it is preferable that the rolling-element fall-out prevention structure locks the rolling elements by rolling-element locking portions protruding from the cage; the rolling-element locking portions are arranged as a continuum from the cage in the pockets of the cage on both an inner circumferential side and outer circumferential side of the peripheral wall, and arranged in pairs at locations plane-symmetrical with respect to a plane which includes a rotation axis of each of the rolling elements and an axis of the cage; and the rolling-element locking portions in each pair on both sides of the axis of the rolling element protrude toward each other.

Also, in the rolling bearing according to the present invention, the rolling-element locking portions are preferable to be formed by applying plastic working to the cage after the rolling elements are housed in the pockets of the cage.

Also, in the rolling bearing according to the present invention, the rolling-element locking portions are preferable to be formed by applying plastic working to the cage before the rolling elements are housed in the pockets of the cage.

In the rolling bearing according to the present invention, the rolling elements are preferable to be needle rollers.

Manufacturing method for rolling bearing according to the present invention: a manufacturing method for a rolling bearing according to the present invention is characterized in that the rolling-element fall-out prevention structure of the cage is formed by using a slide mold.

### Advantages of the Invention

In the rolling bearing according to the present invention, the cage constituting the rolling bearing is formed integrally by metal injection molding, in particular, metal powder injection molding, and comprises the rolling-element fall-out prevention structure. So, according to the rolling bearing according to the present invention, performance as a bearing is improved, and manufacturing cost is reduced by reduction in the number of steps required for production of a rolling bearing. So, the present invention can provide a rolling bearing excellent in quality and cost performance.

Also, the manufacturing method of a rolling bearing according to the present invention uses a slide mold for forming of the rolling-element fall-out prevention structure of the rolling bearing. Thus, the manufacturing method according to the present invention never generate bows and burrs at punched portions when manufacturing method employs conventional press punching and can form shapes with high accuracy.

### BRIEF DESCRIPTION OF THE DRAWINGS

FIG. 1 is a perspective view of a rolling bearing according to one embodiment of the present invention.

FIG. 2 is a cross-sectional view showing main section of the rolling bearing of FIG. 1 to show a shape and forming process of a rolling-element fall-out prevention structure according to the present invention.

FIG. 3 is a perspective view of a rolling bearing according to another embodiment of the present invention.

FIG. 4 is a cross-sectional view showing main section of the rolling bearing of FIG. 3 to show a shape and forming process of a rolling-element fall-out prevention structure according to the present invention.

FIG. 5 is a perspective view of the rolling bearing according to another embodiment of the present invention different from FIG. 3.

FIG. 6 is a cross-sectional view showing main section of the rolling bearing of FIG. 5 to show a shape and forming process of a rolling-element fall-out prevention structure according to the present invention.

### DETAILED DESCRIPTION OF THE EMBODIMENTS

Hereinafter, preferable embodiments of a rolling bearing and a manufacturing method for a rolling bearing according to the present invention will be described below respectively.

A rolling bearing according to the present invention: a rolling bearing according to the present invention uses a cage provided with a plurality of pockets for housing rolling elements are arranged at specific intervals in a circumferential direction in a peripheral wall of a cylindrical member. The cage is characterized in formed integrally by metal powder injection molding, a rolling-element housing space is provided in each of the pockets, and a rolling-element fall-out prevention structure is provided in the rolling-element housing space.

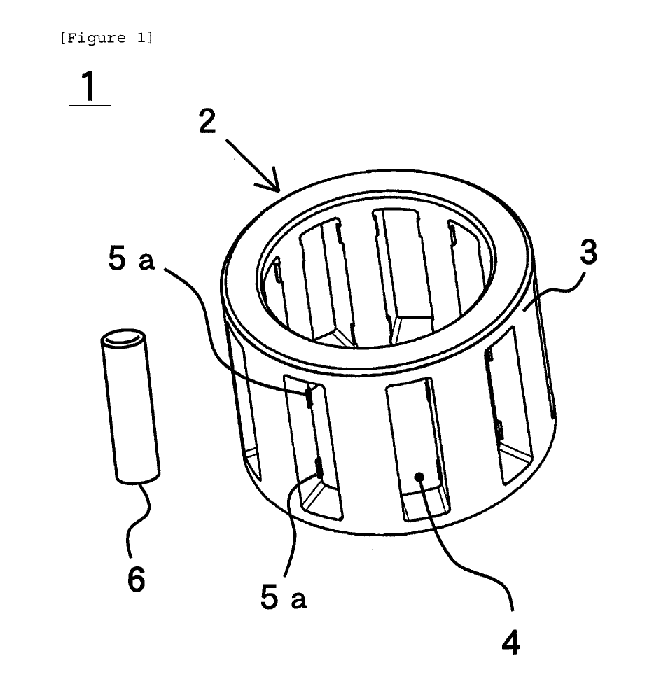

FIG. 1 is a perspective view of a rolling bearing according to one embodiment of the present invention. Note that FIG. 1 exemplifies a so-called needle rolling bearing among types of rolling bearing. A cage 2 exemplified in FIG. 1 is in a state before a rolling-element fall-out prevention structure is provided. As shown in FIG. 1, the rolling bearing (needle rolling bearing) 1 comprises a rolling elements (needle rollers) 6 and a needle rolling bearing cage 2 provided with pockets 4 for housing the rolling elements (needle rollers) 6 in a circumferential direction in a peripheral wall 3 of a cylindrical member of the cage 2. That is, the needle rolling bearing 1 shown in FIG. 1 as the rolling bearing according to the present invention corresponds to a so-called needle roller and cage assembly among types of needle rolling bearing. Demand on the needle rolling bearing 1 has been growing as an important component, especially in automobiles of automatic transmissions (AT) and engines.

As described above, the cage of the rolling bearing according to the present invention is formed integrally by metal injection molding, in particular, metal powder injection molding. By employing metal powder injection molding technology for forming of the cage, a more precisely shaped cage for a rolling bearing than the cage formed by the conventional press-working is supplied. Reasons thereof will be described below.

First, metal injection molding will be demonstrated briefly. The metal injection molding (MIM) is a technology for producing a metal part directly in a shape close to a finished part shape, and is divided into “a method using a solid metal lump as a raw material” and “a method using a metal powder as a raw material.” The former method is a technology for forming a metal part by pouring the metal lump in a molten or semi-molten state into a mold. However, in production of the rolling bearing according to the present invention, the latter technology known as the metal powder injection molding technology has been employed in which a kneaded mixture including metal powder, resin and wax as a binder is injected into a mold.

In the metal powder injection molding according to the present invention, a kneaded mixture including metal powder and an organic binder is injected into a mold. As an injection method, it is preferable to adopt an in-line screw system (hereinafter referred to as a screw system) in general. In the screw system, a kneaded mixture including metal powder and an organic binder is heated at around the melting temperature of the resin to melt (plasticizing) the kneaded mixture and prepare a mixture of molten resin and metal powder, then the mixture is fed into a cylinder of an injection molding machine by a backward movement of a continuously rotating screw, after that, a high pressure generated by forward moving behavior of the screw injects the mixture into the mold at high speed. The molded material solidified obtained by cooling the mixture of molten resin and metal powder injected into the mold by the screw system is further degreased (binder removal) and sintered to finish a product.

Features of the metal powder injection molding technology include: (1) excellent in shape flexibility, (2) excellent in material flexibility, (3) excellent in dimensional accuracy, (4) excellent in mechanical strength, (5) freedom in a post-treatment, (6) suitability to mass production, and (7) excellent advantage in cost. These features will be described below one by one.

Feature (1) described above is an advantage achieved by the characteristic that the metal powder injection molding technology can integrally form a product shape extremely close to a required product shape stably. So, the metal powder injection molding technology reduces the number of parts and can omit post-processing. Also, the metal powder injection molding technology is a resource-saving manufacturing method which can achieve utilization rate of a raw material close to 100% because runners and sprues generate in injection molding in addition to the product can be reused after crushing. Thus, the metal powder injection molding technology can reduce material costs compared to conventional manufacturing methods.

Feature (2) described above is an advantage achieved by the characteristic that the metal powder injection molding technology can use any metal powder as long as finely ground for forming parts in principle. Thus, the metal powder injection molding technology demonstrates its advantages especially in forming difficult-to-process materials into parts or high-melting-point metals into products.

Feature (3) described above is an advantage achieved by the characteristic that the metal powder injection molding technology provides more accurate size and shape of products than a powder metallurgical method employing popular press forming. Note that the metal powder injection molding technology can provide products with further improved accuracy in size and shape as a result of process improvement.

Feature (4) in the metal powder injection molding technology described above is an advantage achieved by the characteristic that a manufacturing method using fine powder with high sinter-ability for injection-molding makes filled density and pressure distribution during molding uniform, binder removal and sintering carried out at relatively low temperatures possible and uniform high density sintering enable. Thus, the metal powder injection molding technology can provide products having higher density (a relative density of 95% or above) and higher mechanical strength than when a powder metallurgical method employing popular press forming is employed.

Feature (5) described above is an advantage achieved by the characteristic that the metal powder injection molding technology can be followed by surface treatment such as plating as well as typical heat treatment to be applied, as for the cast ingots. Thus, the metal powder injection molding technology makes surface improvements carried out depending on required properties relatively free.

Feature (6) described above is an advantage achieved by the characteristic that the metal powder injection molding technology enables continuous production by injection molding using a mold. Thus, the metal powder injection molding technology enables mass production with high productivity.

Feature (7) described above is an advantage achieved by the characteristic that the metal powder injection molding technology can obtain a shape extremely close to a shape of a final product directly by molding in a mold. Thus, the metal powder injection molding technology can reduce manufacturing cost greatly. So, even when a additional step for, for example, parts connection to form a composite part is provided utilizing the saved manufacturing cost, cost performance of the product may be improved.

Next, the rolling-element fall-out prevention structure provided in the cage according to the present invention will be described. The rolling-element fall-out prevention structure of the cage according to the present invention is provided with a so-called undercut shapes formed on the pockets of the cage to reliably prevent the rolling elements from falling off. That is, the rolling bearing according to the present invention is formed integrally by the metal injection molding technology, and the pockets provided in the cage have the undercut shapes.

In the rolling bearing according to the present invention, the rolling-element fall-out prevention structure is preferable to be formed by applying compressive plastic working to an outer edge of a rolling-element housing space from an outer circumferential surface toward a radial center of the cage. The compressive plastic working as referred to herein is the working plastically deforming the cage by applying a compressive force in a substantially vertical direction to the outer circumferential surface of the cage.

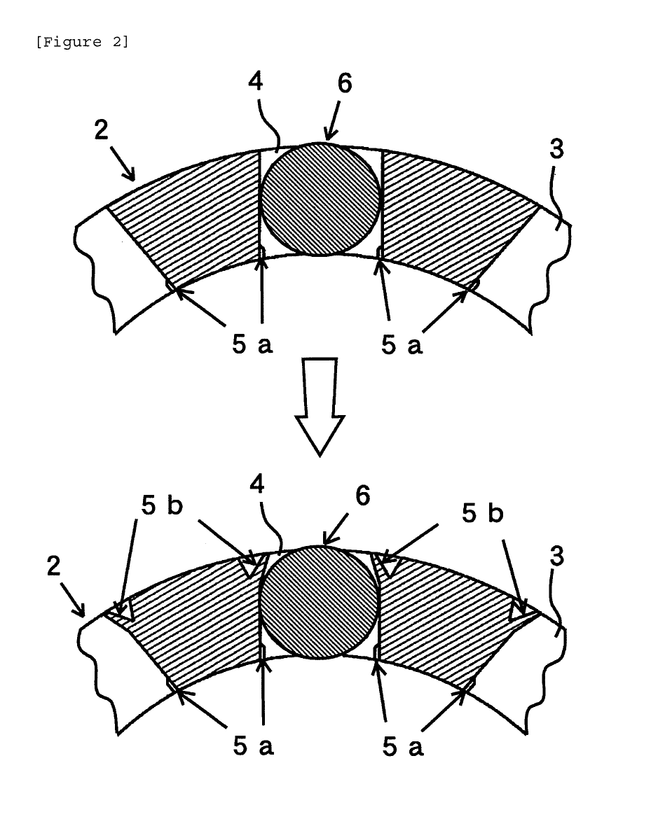

FIG. 2 is a cross-sectional view showing main section of the rolling bearing of FIG. 1 to show a shape and forming process of the rolling-element fall-out prevention structure according to the present invention. Top part of FIG. 2 shows a cross-sectional view of the main section before forming undercut shapes in the rolling-element fall-out prevention structure provided in the cage according to the present invention. Bottom part of FIG. 2 shows a cross-sectional view of the main section after forming undercut shapes in the rolling-element fall-out prevention structure provided in the cage according to the present invention. In this way, FIG. 2 exemplifies the process for forming the rolling-element fall-out prevention structure with the undercut shapes provided in the pockets 4 by applying compressive plastic working to the outer edge of the housing space from the outer circumferential surface toward the radial center of the cage 2 according to the present invention. As exemplified in FIG. 2, the rolling-element fall-out prevention structure provided in the cage 2 according to the present invention is formed by applying compressive plastic working to sink a tip of an acute object with a substantially triangular cross section into the outer circumferential surface near each pocket 4 of the cage 2 toward the radial center.

Also, the rolling-element fall-out prevention structure is preferable to be formed by applying plastic bending to projections protruding radially from the outer circumferential surface of the cage to outward in the rolling bearing according to the present invention. The plastic bending as referred to herein is working to plastically deform the projections at a specific angle by applying bending deformation to the projections.

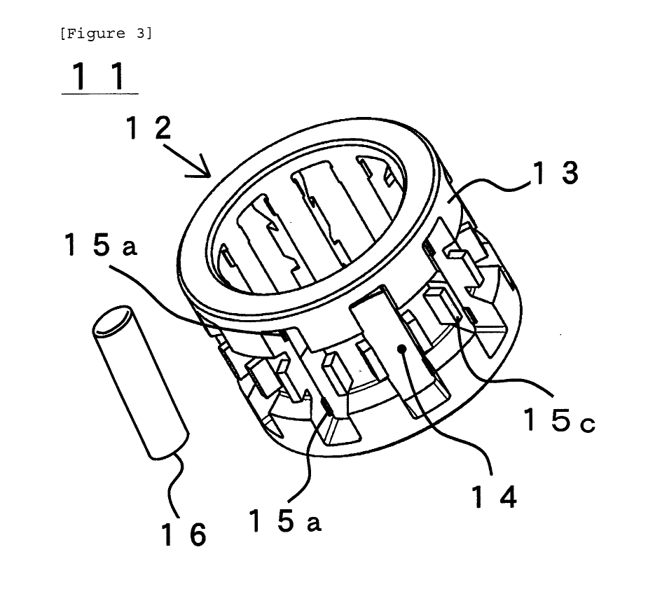

FIG. 3 is a perspective view of a rolling bearing according to another embodiment of the present invention. FIG. 3 exemplifies a so-called needle rolling bearing among types of rolling bearing, as in FIG. 1. A cage 12 exemplified in FIG. 3 is in a state before a rolling-element fall-out prevention structure is provided. As shown in FIG. 3, the rolling bearing (needle rolling bearing) 11 includes a needle rolling bearing cage 12, and rolling elements (needle rollers) 16 and is provided with pockets 14 for housing the rolling elements (needle rollers) 16, in a circumferential direction in a peripheral wall 13 of a cylindrical member of the cage 12.

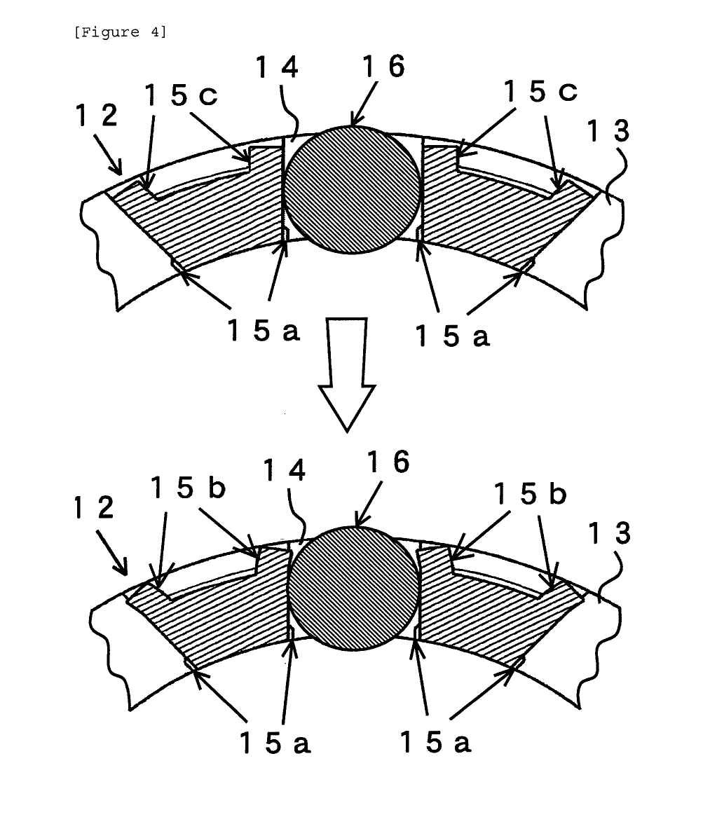

FIG. 4 is a sectional view showing main section of the rolling bearing of FIG. 3 to show a shape and forming process of the rolling-element fall-out prevention structure according to the present invention. FIG. 4 exemplifies the process of forming the rolling-element fall-out prevention structure having the undercut shapes provided in the pockets 14 by applying plastic bending to the projections 15c protruding radially from the outer circumferential surface of the cage 12 to outward. As exemplified in FIG. 4, the rolling-element fall-out prevention structure provided in the cage 12 according to the present invention is formed by applying plastic bending to the projections 15c protruding radially, from the outer circumferential surface near each pocket 14 of the cage 12 to outward.

Note that, although FIGS. 3 and 4 show an embodiment different from the rolling bearing 1 disclosed in FIGS. 1 and 2 as another embodiment, other embodiments of the rolling bearing according to the present invention are not limited to the embodiment shown in FIGS. 3 and 4. For example, the projections 15c protruding radially from the outer circumferential surface of the cage 12 to outward may have a shape different from the shape shown in FIGS. 3 and 4.

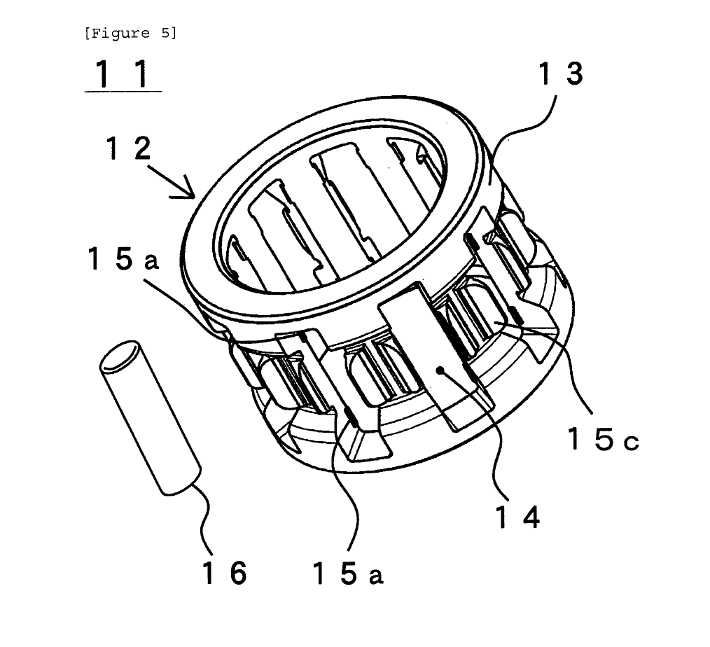

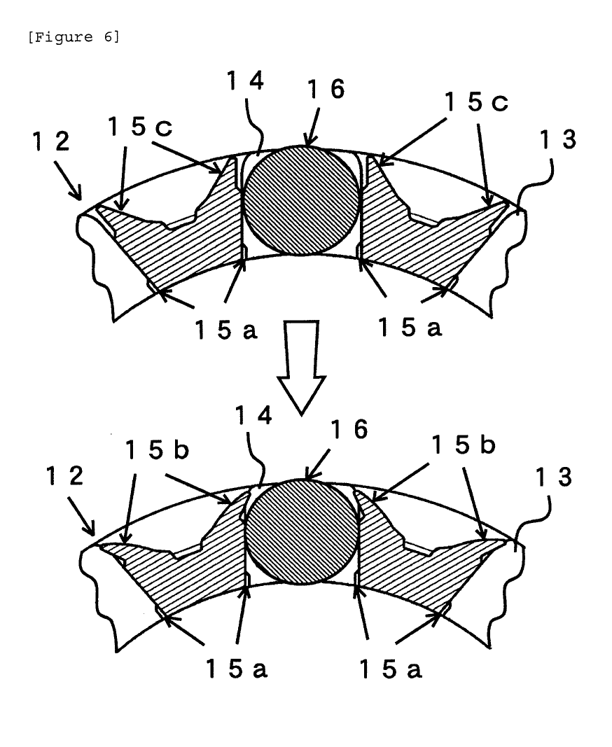

FIG. 5 is a perspective view of the rolling bearing according to the other embodiment of the present invention different from FIG. 3. FIG. 6 is a sectional view showing main section of the rolling bearing of FIG. 5 to show a shape and forming process of a rolling-element fall-out prevention structure according to the present invention. The rolling bearing shown in FIGS. 5 and 6 differs from the rolling bearing shown in FIGS. 3 and 4 especially in the shape (thickness) of the projections 15c protruding radially from the outer circumferential surface of the cage 12 to outward. In this way, the rolling bearing according to the present invention can arrange shape of the projections 15c appropriate depending on the material and usage of the cage 12. Note that, as the rolling bearing 11 shown in FIGS. 5 and 6 has a basic embodiment common with the rolling bearing shown in FIGS. 3 and 4 except the shape of the projections 15c, description of the basic embodiment will be omitted.

In the rolling bearing according to the present invention, the rolling-element fall-out prevention structure locks the rolling elements by rolling-element locking portions protruding from the cage. Preferably the rolling-element locking portions are arranged as a continuum from the cage, in the pockets of the cage on both an inner circumferential side and outer circumferential side of the peripheral wall, and arranged in pairs at locations plane-symmetrical with respect to a plane which includes a rotation axis of each of the rolling elements and an axis of the cage. Furthermore, the rolling-element locking portions in each pair on both sides of the axis of the rolling element are preferable to protrude toward each other.

The rolling-element locking portions herein are formed to make the pockets provided in the cage undercut shape after the cage according to the present invention is molded by metal injection molding. As shown in FIG. 2, in the rolling bearing according to an embodiment of the present invention, the rolling-element locking portions 5b are formed when compressive plastic working is applied from the outer circumferential surface near each pocket 4 of the cage 2 toward the radial center. Also, as shown in FIGS. 4 and 6, in the rolling bearing according to another embodiment of the present invention, the rolling-element locking portions 15b are formed by applying plastic bending to the projections 15c protruding radially from the outer circumferential surface near each pocket 4 of the cage 12 to outward.

Note that, as shown in FIGS. 1 to 6, the cages 2 and 12 according to the present invention prevent the rolling elements 6 and 16 from falling off by arranging rolling-element locking portions 5a and 15a as a continuum on the inner circumferential side of the peripheral wall 3 and 13 in addition to the rolling-element locking portions 5b and 15b formed on the outer circumferential side of the peripheral wall 3 and 13. Also, as shown in FIGS. 1 to 6, the rolling-element locking portions 5a, 5b, 15a, and 15b are arranged in pairs at locations plane-symmetrical with respect to the plane which includes the rotation axis of the respective rolling elements 6 and 16 and the axis of the cage 2 and 12. Furthermore, in the cages 2 and 12 according to the present invention, so-called undercut shapes is formed because the rolling-element locking portions 5a, 5b, 15a, and 15b arranged in each pair provided in the cages on both sides of the axis of each rolling element 6 and 16 housed in the cage 2 and 12 protrude toward each other.

In this way, in the rolling-element fall-out prevention structure provided in the cage 2 and 12 according to the present invention, the rolling-element locking portions 5a, 5b, 15a, and 15b arranged in pairs on both sides of the axis of each rolling element 6 and 16 protrude toward each other reliably prevent the rolling elements 6 and 16 from falling off. Also, since the rolling-element locking portions 5a and 5b and 15a and 15b are formed integrally with the cage, durability (strength) of the cage 2 and 12 according to the present invention is improved compared with a cage retrofitted with members corresponding to the rolling-element locking portions by a connecting process, for example.

The rolling-element fall-out prevention structures provided in the cages 2 and 12 according to the present invention have been described with reference to FIGS. 1 to 6, but the number and arrangement locations of the rolling-element locking portions 5a and 5b; and 15a and 15b constituting the fall-out prevention structure are not limited to those examples in the figures. That is, the number and arrangement locations of the rolling-element locking portions 5a and 5b; and 15a and 15b formed in the cage 2 and 12 according to the present invention is arranged arbitrarily depending on the usage and the like of the rolling bearing 1 and 11.

As described above, in the cages 2 and 12 according to the present invention, the rolling-element fall-out prevention structure is provided by making each pocket 4 and 14 of the cages so-called undercut shapes through forming of each rolling-element locking portion 5b and 15b on both side of the axis of each rolling element 6 and 16 protrude toward each other of its paired counterpart arranged on the opposite side. That is, the rolling bearings 1 and 11 according to the present invention is provided with the rolling-element fall-out prevention structure provided with so-called undercut shapes is added to the internal geometry of each pocket 4 and 14 for housing the rolling element by a minimal secondary step after the cage 2 and 12 is molded by metal injection molding. Note that, with regard to the rolling-element locking portions 15b shown in FIGS. 3 to 6, it is preferable to form by a composite mold when the pocket 14 is formed by a slide mold as described above to increase the efficiency and cost reduction in the production.

In the cages 2 and 12 according to the present invention, grinding or other machining may be applied to inner surfaces of the pockets 4 and 14 depending on requirement after the molded article produced by metal powder injection molding is sintered or heat treated. As described above, when grinding or other machining is further applied to the inner surfaces of the pockets 4 and 14 in this way, smoothness of the inner surfaces of the pockets 4 and 14 is further improved in the cages 2 and 12, and frictional resistance against the rolling elements 6 and 16 housed in the cage is reduced.

In the rolling bearings 1 and 11 according to the present invention, it is also preferable that the rolling-element locking portions 5b and 15b formed in the cage 2 and 12 of the rolling bearing are formed by applying plastic working to the cages 2 and 12 after the rolling elements 6 and 16 are housed in the pockets 4 and 14 of the cage.

When the cages 2 and 12 are plastically deformed by processing for forming of the rolling-element locking portions 5b and 15b after the rolling elements 6 and 16 are housed in the pockets 4 and 14 in the cages 2 and 12 of the rolling bearing, production efficiency of the rolling bearings 1 and 11 according to the present invention increases. That is, the rolling bearings 1 and 11 according to the present invention are the rolling bearings provided with a structure adapted to prevent the rolling elements 6 and 16 from falling off in which low production cost is achieved.

Also, in the rolling bearings 1 and 11 according to the present invention, it is preferable that the rolling-element locking portions 5b and 15b formed in the cage 2 and 12 of the rolling bearing are formed by applying plastic working to the cages 2 and 12 before the rolling elements 6 and 16 are housed in the pockets 4 and 14 of the cages 2 and 12.

The rolling-element fall-out prevention structure of the rolling bearings 1 and 11 according to the present invention is not limited to a configuration in which the rolling-element locking portions 5b and 15b are formed after the rolling elements 6 and 16 are housed in the pockets 4 and 14 in the cages 2 and 12 of the rolling bearing. Note that, when the rolling-element locking portions 5b and 15b are formed by plastically deforming the cages 2 and 12 after the rolling elements 6 and 16 are housed in the pockets 4 and 14, the rolling elements 6 and 16 sometimes generate flaws depending on the facilities used or manufacturing conditions established. In such a case, the cages 2 and 12 according to the present invention can prevent defects such as the flaws described above and thereby stabilize product quality because the rolling-element locking portions 5b and 15b are formed by applying plastic working to the cages 2 and 12 before the rolling elements 6 and 16 are formed.

As described above, the rolling bearings 1 and 11 according to the present invention are assumed to adopt the metal powder injection molding technology in the manufacturing. Then, the rolling-element fall-out prevention structures of the rolling bearings 1 and 11 according to the present invention have a so-called undercut shape by forming each rolling-element locking portions 5b and 15b protrude toward its paired counterpart provided on the opposite side of each rolling elements 6 and 16 housed in the cages 2 and 12, by applying minimal plastic working to the cage 2 and 12. Furthermore, the cages 2 and 12 of the rolling bearing 1 and 11 according to the present invention formed by the metal powder injection molding technology is formed into complex shapes with high accuracy and with a smaller number of processing steps than conventional cages produced by processing strip-shaped members. Thus, the cages 2 and 12 according to the present invention processed simultaneously with forming of the cages during their manufacturing makes it possible to reduce the number of processing steps, to provide high-accuracy product shape in a stable manner, and improve yields compared to conventional cages. So, the initial cost for facilities when the metal powder injection molding technology is employed will be recovered in a short period of time in mass production of products.

Note that, design requirements for rolling bearings include (a) long service life, (b) low torque, and (c) excellent in high-speed rotation performance. The long service life reduces the frequency of rolling bearing rearrangement operations, the low torque reduces energy used for rotation and heat generation, and excellent high-speed rotation performance contributes to the improvement in the performance of the machine. In this respect, the rolling bearings 1 and 11 according to the present invention meet the design requirements described above because of advantages including low starting resistance, small power loss and low wear, because the cage is formed with high accuracy in size and shape. Also, the rolling bearings 1 and 11 according to the present invention can minimize frictional resistance by keeping contact pressure of the rolling bearings against the supporting member uniform because the pockets 4 and 14 are arranged accurately and well balanced with constant intervals.

Also, in the rolling bearings 1 and 11 according to the present invention, the rolling elements 6 and 16 are preferable to be needle rollers. A so-called needle rolling bearing whose rolling elements 6 and 16 are needle rollers has a small diameter difference between inner race and outer race and can be used in severe environments than slide bearings of the same size (e.g., a ball bearing whose rolling elements are balls). That is, the needle rolling bearing can be used suitably for internal combustion engines for example because the so-called needle rolling bearing is a machine element which enables downsizing of the entire machine and withstands high loads.

Method for manufacturing a rolling bearing according to the present invention: in a manufacturing method of the rolling bearings 1 and 11, a slide mold is used for forming of the rolling-element fall-out prevention structure provided in the cages 2 and 12 of the rolling bearing.

The pockets 4 and 14 in the cages 2 and 12 according to the present invention are formed by pull off of a mold component known as a blade (slide mold) from the mold for injection molding in the employed metal injection molding technology before removal of the product. Note that, a molded article with undercut shapes is obtained by sliding a slide core in synchronization with opening and closing of the mold in the metal injection molding. However, manufacturing cost for forming of undercut shapes simultaneously with a molding process of metal injection molding increase, because a complicated mold is required. Therefore, in the rolling-element fall-out prevention structure provided in the cages 2 and 12 according to the present invention, undercut shapes are formed at the same time in a sizing step carried out to ensure accuracy. That is, in the cages 2 and 12 shown in FIGS. 1 to 6, undercut shapes are provided in the pockets 4 and 14 by applying a minimal additional step to the rolling-element locking portions 5b and 15b on the outer circumferential surface.

With the manufacturing method for a rolling bearing according to the present invention, the adoption of a slide mold makes it possible to reduce the number of processing steps compared to press punching method. Further, shapes with high accuracy are formed because of eliminated burrs and shear drops on punched surfaces generate in press punching. So, the manufacturing method of a rolling bearing according to the present invention improves product yields and reduces manufacturing cost compared to when a manufacturing method based on conventional press punching is employed. Also, when the rolling elements 6 and 16 according to the present invention are needle rollers, both features in the metal powder injection molding technology and the so-called needle rolling bearing is utilized in a wide range of mechanical parts.

Thus, with the rolling bearing according to the present invention, performance as a bearing is improved by that the cage is formed integrally with the rolling bearing by metal injection molding, particularly metal powder injection molding, and provided with the rolling-element fall-out prevention structure. Also, the manufacturing method of a rolling bearing according to the present invention reduces the number of steps for manufacturing the rolling bearing, thereby reduces manufacturing cost, and provides a high quality rolling bearing. Note that, although the rolling bearing has been shown as being a radial bearing in the embodiments, the rolling bearing according to the present invention is not limited to the radial bearing, but a thrust rolling bearing, for example.

### INDUSTRIAL APPLICABILITY

The rolling bearing according to the present invention is suitably used in various parts of automobiles, household electrical appliances, office automation equipment for example because of a high level of flexibility in material selection, reduced costs with high quality, and applicability in any environment,.

### REFERENCE SIGNS LIST

1, 11: Rolling bearing
2, 12: Cage
3, 13: Peripheral wall
4, 14: Pocket
5a, 15a: Rolling-element locking portion (on the inner circumferential side of the peripheral wall)
5b, 15b: Rolling-element locking portion (on the outer circumferential side of the peripheral wall)
6, 16: Rolling element

1. A rolling bearing comprising a cage provided with a plurality of pockets for housing and hold rolling elements arranged at specific intervals in a circumferential direction in a peripheral wall of a cylindrical member, wherein:
the cage is formed integrally by metal powder injection molding; and
the cage includes a housing space for the rolling elements and a rolling-element fall-out prevention structure provided in the housing space.

2. The rolling bearing according to claim 1, wherein the rolling-element fall-out prevention structure is formed by applying compressive plastic working to an outer edge of the housing space in a direction from an outer circumferential surface toward a radial center of the cage.

3. The rolling bearing according to claim 1, wherein the rolling-element fall-out prevention structure is formed by applying plastic bending to projections radially protruding from an outer circumferential surface of the cage to outward.

4. The rolling bearing according to claim 1, wherein:
the rolling-element fall-out prevention structure locks the rolling elements by rolling-element locking portions protruding from the cage;
the rolling-element locking portions are continuously arranged from the cage, in the pockets of the cage on both an inner circumferential side and outer circumferential side of the peripheral wall, and arranged in pairs at locations plane-symmetrical with respect to a plane which includes a rotation axis of each of the rolling elements and an axis of the cage; and
the rolling-element locking portions in each pair on both sides of the axis of the rolling element protrude toward each other.

5. The rolling bearing according to claim 1, wherein the rolling-element locking portions are formed by applying plastic working to the cage after the rolling elements are housed in the pockets of the cage.

6. The rolling bearing according to claim 1, wherein the rolling-element locking portions are formed by applying plastic working to the cage before the rolling elements are housed in the pockets of the cage.

7. The rolling bearing according to claim 1, wherein the rolling elements are needle rollers.

8. A manufacturing method for the rolling bearing according to claim 1, wherein
the rolling-element fall-out prevention structure of the cage is formed using a slide mold.
